(19) United States
(12) Patent Application Publication
(10) Pub. No.: US 2025/0125945 A1
(43) Pub. Date: Apr. 17, 2025

(54) ENHANCED SECURE AUTHENTICATION TECHNIQUES USING QUANTUM KEY DISTRIBUTION PROTOCOL

(71) Applicant: BANK OF AMERICA CORPORATION, Charlotte, NC (US)

(72) Inventors: Mohammad Shahnawaz Akhter, New Delhi (IN); Ramakrishna Banda, Hyderabad, Telangana (IN); Usha Kiran Maddela

(73) Assignee: BANK OF AMERICA CORPORATION, Charlotte, NC (US)

(21) Appl. No.: 18/487,358

(22) Filed: Oct. 16, 2023

(51) Int. Cl. H04L 9/08

(52) U.S. Cl. CPC H04L 9/08; G06N 10/40

(57) ABSTRACT

Embodiments of the present invention provide a system for securely authenticating users using quantum key distribution protocol. The system is configured for receiving an authentication request comprising at least one credential from a user, via a user device, calculating an authentication match score for the at least one credential, retrieving an authentication token associated with the user stored on an external physical device connected to the user device, retrieving an enrollment match score associated with the authentication token of the user, validating the at least one credential by comparing the authentication match score of the at least one credential with the enrollment match score associated with the user, determining that the validation is not successful, and performing a quantum key distribution secret verification based on an enrollment common base stored on a quantum computing platform during the enrollment phase via a quantum communication network.

### BACKGROUND

There exists a need for a system that can securely authenticate users using quantum key distribution protocol.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for securely authenticating users using quantum key distribution protocol. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives an authentication request comprising at least one credential from a user, via a user device, in response to receiving the authentication request, calculates an authentication match score for the at least one credential, retrieves an authentication token associated with the user stored on an external physical device connected to the user device, retrieves an enrollment match score associated with the authentication token of the user, wherein the enrollment match score is generated and scored during an enrollment phase of the user, validates the at least one credential by comparing the authentication match score of the at least one credential with the enrollment match score associated with the user, and determines if the validation is successful based on comparing the authentication match score of the at least one credential with the enrollment match score.

In some embodiments, the present invention determines that the validation is not successful based on determining that the authentication match score is over a predetermined threshold associated with the enrollment match score and performs a quantum key distribution secret verification based on an enrollment common base stored on a quantum computing platform during the enrollment phase via a quantum communication network.

In some embodiments, the present invention performs the quantum key distribution secret verification based on generating a new common base for the at least one credential received with the authentication request, communicating with the quantum computing platform about the enrollment common base stored on the quantum computing platform, and comparing the new common base with the enrollment common base based on communicating with the quantum computing platform over the quantum communication network.

In some embodiments, the present invention determines that the new common base matches the enrollment common base based on comparing the new common base with the enrollment common base, determines that the quantum key distribution secret verification is successful based on determining that the new common base matches the enrollment common base, and authenticates the user based on determining that the quantum key distribution secret verification is successful.

In some embodiments, the present invention determines that the new common base does not match the enrollment common base based on comparing the new common base with the enrollment common base, determines that the quantum key distribution secret verification is not successful based on determining that the new common base matches the enrollment common base, and denies authentication of the user based on determining that the quantum key distribution secret verification is successful.

In some embodiments, the present invention receives an enrollment request from the user at a previous instance, performs enrollment of the user, wherein the enrollment of the user during the enrollment phase comprises receiving one or more enrollment credentials from the user device of the user, extracting one or more features from the one or more enrollment credentials, generating the enrollment match score from the one or more features extracted from the one or more enrollment credentials, generating the authentication token and associate the authentication token with the enrollment match score of the user, storing the authentication token and the enrollment match score in the external physical device, generating the enrollment common base based on the enrollment match score of the user, and transmitting the enrollment common base to the quantum computing platform via the quantum communication network.

In some embodiments, the at least one credential comprises biometric credentials.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for securely authenticating users using quantum key distribution protocol, in accordance with an embodiment of the invention;

FIG. 2 provides a block diagram illustrating the entity system 200 of FIG. 1, in accordance with an embodiment of the invention;

FIG. 3 provides a block diagram illustrating an enhanced secure authentication system 300 of FIG. 1, in accordance with an embodiment of the invention;

FIG. 4 provides a block diagram illustrating the computing device system 400 of FIG. 1, in accordance with an embodiment of the invention;

FIG. 5 presents a block diagram illustrating the quantum computing platform 500 of FIG. 1, in accordance with embodiments of the present invention;

FIG. 6 provides a flowchart illustrating a process flow for enrolling one or more users for an authentication service provided by the enhanced secure authentication system 300, in accordance with an embodiment of the invention;

FIG. 7 provides a flowchart illustrating a process flow for processing an authentication request received from one or more users, in accordance with an embodiment of the invention;

FIG. 8 provides a flowchart illustrating a process flow for performing a quantum key distribution secret verification to authenticate users, in accordance with an embodiment of the invention;

FIG. 9 provides a block diagram illustrating the process of enrolling one or more users for the authentication service provided by the enhanced secure authentication system 300, in accordance with an embodiment of the invention; and

FIG. 10 provides a block diagram illustrating the process of securely authenticating users using quantum key distribution protocol, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that has one or more users (e.g., customers) and performs one or more actions for customers based on verifying authenticity of the customers. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications, systems, servers, and/or devices provided by the entity and/or the system of the present invention. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, a quantum computer is any computer that utilizes the principles of quantum physics to perform computational operations. Several variations of quantum computer design are known, including photonic quantum computing, superconducting quantum computing, nuclear magnetic resonance quantum computing, and/or ion-trap quantum computing. Regardless of the particular type of quantum computer implementation, all quantum computers encode data onto qubits. Whereas classical computers encode bits into ones and zeros, quantum computers encode data by placing a qubit into one of two identifiable quantum states. Unlike conventional bits, however, qubits exhibit quantum behavior, allowing the quantum computer to process a vast number of calculations simultaneously.

A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously.

In a quantum computer with n qubits, the quantum computer can be in a superposition of up to 2ⁿ states simultaneously. By comparison, a classical computer can only be in one of the 2ⁿ states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three qubit system can store the information of eight classical bits, four qubits can store the information of sixteen classical bits, and so on. A quantum computer with three hundred qubits could possess the processing power equivalent to the number of atoms in the known universe.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally speaking, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present invention make use of quantum ability of optimization by utilizing a quantum computer in conjunction with a classical computer. Such a configuration enables the present invention to take advantage of quantum speedup in solving optimization problems, while avoiding the drawbacks and difficulty of implementing quantum computing to perform non-optimization calculations. Examples of quantum computers that can be used to solve optimization problems parallel to a classic system are described in, for example, U.S. Pat. Nos. 9,400,499, 9,207,672, each of which is incorporated herein by reference in its entirety.

Typically, the process of authenticating users is crucial step while allowing the users to access resources (e.g., cash in financial accounts, computing systems, databases, or the like) or perform actions associated with resources. However, unauthorized users always attempt to gain access to the resources of the authorized users by any of the misappropriation means such as mimicking credentials of the authorized users, cloning, and/or the like. Additionally, in existing authentication methods, credentials received along with an authentication request are validated against stored credentials for validation. However, for some credentials such as biometrics (e.g., fingerprint, voice recognition, or the like), authenticating users based on an exact match of authentication credentials is highly unlikely (i.e., a 100% matching of authentication credentials is not possible) and therefore, designing an authentication process that doesn't rely on exact matching of credentials may result in false negatives where the system may not recognize true credentials of authorized users and may also increase false positives associated with misappropriated credentials mimicked by unauthorized users. As such, there exists a need for a system that can overcome these problems and authenticate users to prevent misappropriation of authentication credentials.

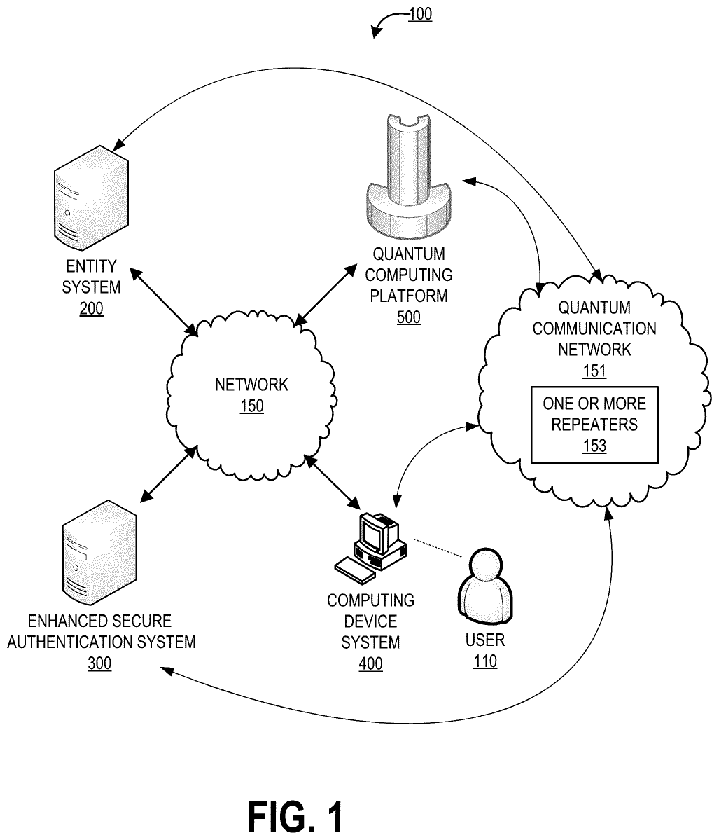

FIG. 1 provides a block diagram illustrating a system environment 100 for securely authenticating users using quantum key distribution protocol, in accordance with an embodiment of the invention. As illustrated in FIG. 1, the environment 100 includes an enhanced secure authentication system 300, an entity system 200, a computing device system 400, and a quantum computing platform 500. One or more users 110 may be included in the system environment 100, where the users 110 interact with the other entities of the system environment 100 via a user interface of the computing device system 400. In some embodiments, the one or more user(s) 110 of the system environment 100 may be customers of the entity. In some embodiments, the one or more users 110 of the system environment 100 may be potential customers of the entity.

The entity system(s) 200 may be any system owned or otherwise controlled by an entity to support or perform one or more process steps described herein. In some embodiments, the entity is a financial institution. In some embodiments, the entity may be a non-financial institution. In some embodiments, the entity may be any organization that requires authentication of users.

The enhanced secure authentication system 300 is a system of the present invention for performing one or more process steps described herein. In some embodiments, the enhanced secure authentication system 300 may be an independent system. In some embodiments, the enhanced secure authentication system 300 may be a part of the entity system 200.

The enhanced secure authentication system 300, the entity system 200, the quantum computing platform 500, and the computing device system 400 may be in network communication across the system environment 100 through a network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the enhanced secure authentication system 300 is configured to communicate information or instructions with the entity system 200, and/or the computing device system 400 across the network 150.

In some embodiments, the enhanced secure authentication system 300, the entity system 200, the quantum computing platform 500, and the computing device system 400 may also be in network communication across the system environment 100 through a quantum communication network 151 for performing one or more steps described in this invention. The quantum communication network 151 uses quantum properties of photons to encode information. For example, photons polarized in one direction (for instance, in the direction that would allow them to pass through polarized sunglasses) are associated with the value ‘one’ and photons polarized in the opposite direction (so they don't pass through the sunglasses) are associated with the value ‘zero’. The quantum communication network 151 may follow quantum communication protocols for communicating and thereby allowing the quantum state of photons to carry information from sender to receiver through the quantum communication network 151.

The quantum communication network 151 uses quantum phenomena such as superposition, no-cloning, and entanglement that are not available to classical networks. Before the photon is measured, it exists in a superposition of all its possible quantum states, each with a corresponding probability. Measurement selects one among these states. The photon's quantum state cannot be measured without causing a disturbance nor can an arbitrary, unknown quantum state be copied as no cloning is allowed, thereby making the quantum communication network 151 robust and secure.

As shown, the quantum communication network 151 comprises one or more repeaters 153 for transmission. The one or more repeaters 153 use entanglement swapping technique that uses teleportation to create long-distance entanglement from a chain of connected repeaters which generate many short-distance entanglements. In some embodiments, the enhanced secure authentication system 300, the entity system 200, the computing device system 400, and the quantum computing platform 500 may communicate only via the quantum communication network 151.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the enhanced secure authentication system 300, and/or entity system 200 across the network 150. In some embodiments, the computing device system 400 may be any device of an employee of the entity. The quantum computing platform 500 is used to process one or more steps of the process flows described herein.

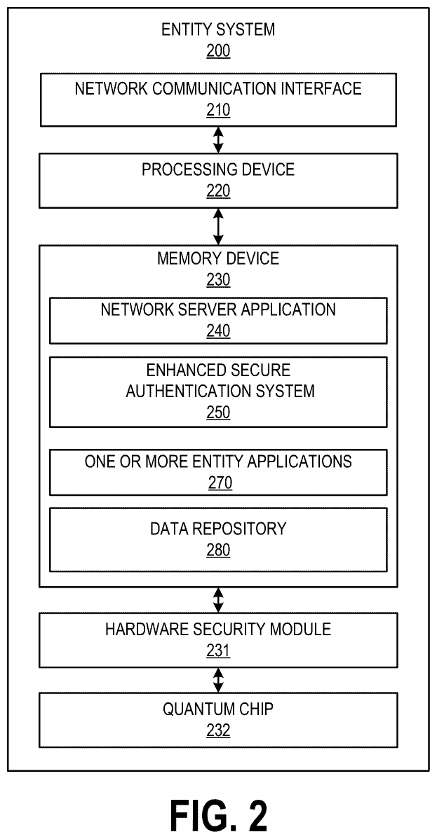

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by an entity, such as a financial institution. In some embodiments, the entity system 200 is operated by an entity, such as a non-financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, an enhanced secure authentication application 250, one or more entity applications 270, and a data repository 280. The one or more entity applications 270 may be any applications developed, supported, maintained, utilized, and/or controlled by the entity. Entity resource data 283 may comprise any data associated with the one or more entity resources of the entity. The computer-executable program code of the network server application 240, the enhanced secure authentication application 250, the one or more entity application 270 to perform certain logic, data-extraction, and data-storing functions of the entity system 200 described herein, as well as communication functions of the entity system 200.

The network server application 240, the enhanced secure authentication application 250, and the one or more entity applications 270 are configured to store data in the data repository 280 or to use the data stored in the data repository 280 when communicating through the network communication interface 210 with the enhanced secure authentication system 300, and/or the computing device system 400 to perform one or more process steps described herein. In some embodiments, the entity system 200 may receive instructions from the enhanced secure authentication system 300 via the enhanced secure authentication application 250 to perform certain operations. The enhanced secure authentication application 250 may be provided by the enhanced secure authentication system 300. The one or more entity applications 270 may be any of the applications used, created, modified, facilitated, and/or managed by the entity system 200.

The entity system 200 further comprises a hardware security module 231 for storing one or more authentication tokens. In some embodiments, the hardware security module 231 may be a physical external device that is connected to the entity system 200. In some embodiments, the hardware security module 231 may be a physical external device that is embedded into the entity system 200. The entity system 200 further comprises a quantum chip 232, where the quantum chip is configured for generating quantum key distribution protocols used by the system of the present invention for network communications. In some embodiments, instead of the quantum chip 232 a quantum simulator can be used that performs at least some actions as that of the quantum chip 232. In some embodiments, the quantum chip 232 may be an external chip that is connected to the entity system 200. In some embodiments, the quantum chip 232 may be embedded into the entity system 200.

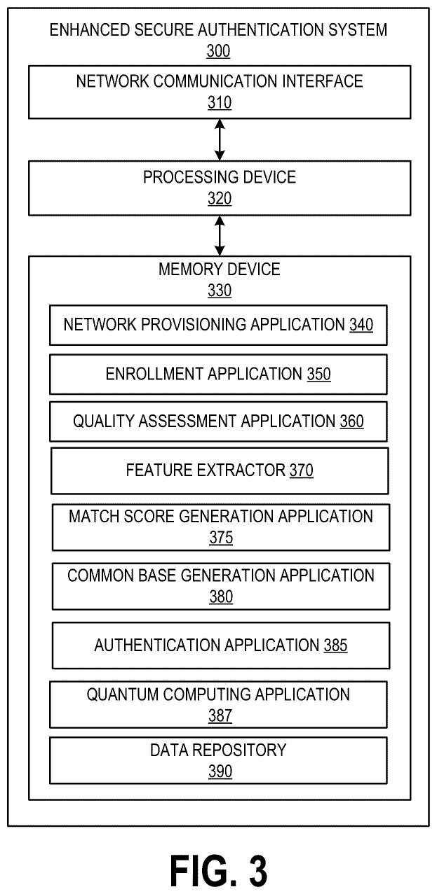

FIG. 3 provides a block diagram illustrating the enhanced secure authentication system 300 in greater detail, in accordance with embodiments of the invention. As illustrated in FIG. 3, in one embodiment of the invention, the enhanced secure authentication system 300 includes one or more processing devices 320 operatively coupled to a network communication interface 310 and a memory device 330. In certain embodiments, the enhanced secure authentication system 300 is operated by an entity, such as a financial institution. In some embodiments, the enhanced secure authentication system 300 is owned or operated by the entity of the entity system 200. In some embodiments, the enhanced secure authentication system 300 may be an independent system. In alternate embodiments, the enhanced secure authentication system 300 may be a part of the entity system 200. In some embodiments, the enhanced secure authentication system may be a part of the computing device system 400.

It should be understood that the memory device 330 may include one or more databases or other data structures/repositories. The memory device 330 also includes computer-executable program code that instructs the processing device 320 to operate the network communication interface 310 to perform certain communication functions of the enhanced secure authentication system 300 described herein. For example, in one embodiment of the enhanced secure authentication system 300, the memory device 330 includes, but is not limited to, a network provisioning application 340, an enrollment application 350, a quality assessment application 360, a feature extractor 370, a match score generation application 375, a common base generation application 380, an authentication application 385, a quantum computing application 387, and a data repository 390 comprising any data processed or accessed by one or more applications in the memory device 330. The computer-executable program code of the network provisioning application 340, the enrollment application 350, the quality assessment application 360, the feature extractor 370, the match score generation application 375, the common base generation application 380, the quantum computing application 387, and the authentication application 385 may instruct the processing device 320 to perform certain logic, data-processing, and data-storing functions of the enhanced secure authentication system 300 described herein, as well as communication functions of the enhanced secure authentication system 300.

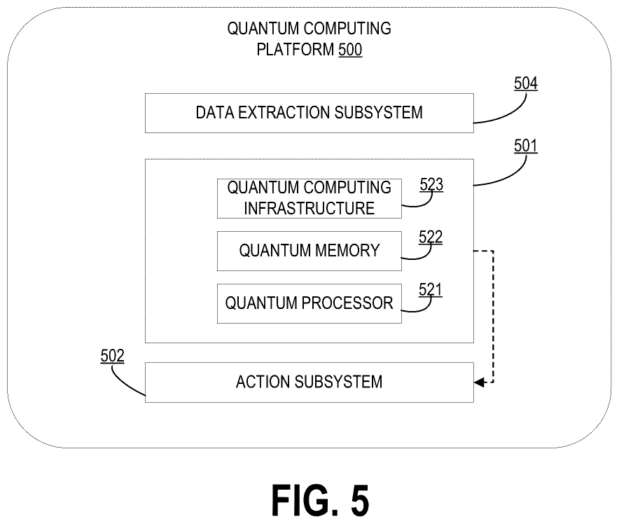

The network provisioning application 340, the enrollment application 350, the quality assessment application 360, the feature extractor 370, the match score generation application 375, the common base generation application 380, the quantum computing application 387, and the authentication application 385 are configured to invoke or use the data in the data repository 390 when communicating through the network communication interface 310 with the entity system 200, and/or the computing device system 400. In some embodiments, the network provisioning application 340, the enrollment application 350, the quality assessment application 360, the feature extractor 370, the match score generation application 375, the common base generation application 380, the quantum computing application 387, and the authentication application 385 may store the data extracted or received from the entity system 200, and the computing device system 400 in the data repository 390. In some embodiments, the network provisioning application 340, the enrollment application 350, the quality assessment application 360, the feature extractor 370, the match score generation application 375, the common base generation application 380, the quantum computing application 387, and the authentication application 385 may be a part of a single application. The functionalities of the network provisioning application 340, the enrollment application 350, the quality assessment application 360, the feature extractor 370, the match score generation application 375, the common base generation application 380, the quantum computing application 387, and the authentication application 385 are explained in greater detail in FIG. 5.

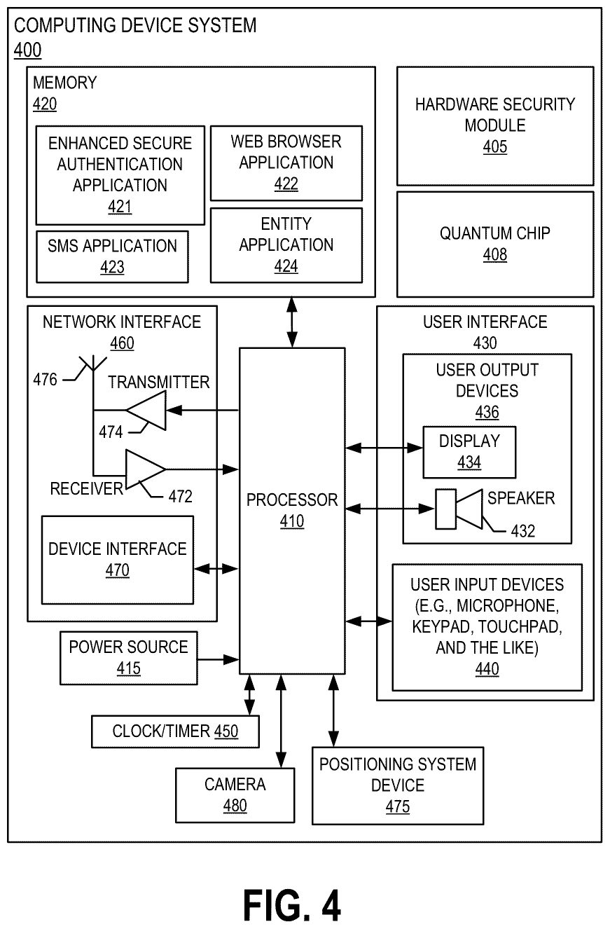

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

In some embodiments, the processor 410 is configured to communicate with one or more other devices via the quantum communication network 151. In some embodiments, the processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an enhanced secure authentication application 421, entity application 424. These applications also typically instructions to a graphical user interface (GUI) on the display 430 that allows the user 110 to interact with the entity system 200, the enhanced secure authentication system 300, and/or other devices or systems. The memory 420 of the computing device system 400 may comprise a Short Message Service (SMS) application 423 configured to send, receive, and store data, information, communications, alerts, and the like via a wireless network. In some embodiments, the enhanced secure authentication application 421 provided by the enhanced secure authentication system 300 allows the user 110 to access the enhanced secure authentication system 300. In some embodiments, the entity application 424 provided by the entity system 200 and the enhanced secure authentication application 421 allow the user 110 to access the functionalities provided by the enhanced secure authentication system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

The computing device system 400 further comprises a hardware security module 405 for storing one or more authentication tokens. In some embodiments, the hardware security module 405 may be a physical external device that is connected to the computing device system 400. In some embodiments, the hardware security module 405 may be a physical external device that is embedded into the computing device system 400. The computing device system 400 further comprises a quantum chip 408, where the quantum chip is configured for generating quantum key distribution protocols used by the system of the present invention for network communications. In some embodiments, instead of the quantum chip 408 a quantum simulator can be used that performs at least some actions as that of the quantum chip 408. In some embodiments, the quantum chip 408 may be an external chip that is connected to the computing device system 400. In some embodiments, the quantum chip 408 may be embedded into the computing device system 400.

FIG. 5 is a schematic diagram of an exemplary Quantum computing platform 500 that can be used in parallel with a classical computer to solve optimization problems. The Quantum computing platform 500 is comprised of a Data Extraction Subsystem 504, a Quantum Computing Subsystem 501, and an Action Subsystem 505. As used herein, the term “subsystem” generally refers to components, modules, hardware, software, communication links, and the like of particular components of the system. Subsystems as contemplated in embodiments of the present invention are configured to perform tasks within the system as a whole.

As depicted in FIG. 5, the Data Extraction Subsystem 504 communicates with the system of the invention to extract data for optimization. It will be understood that any method of communication between the Data Extraction Subsystem 504 and the network includes, but is not limited to quantum network communication, wired communication, Radiofrequency (RF) communication, Bluetooth®, WiFi, and the like. The Data Extraction Subsystem 504 then formats the data for optimization in the Quantum Computing Subsystem.

As further depicted in FIG. 5, the Quantum Computing Subsystem 501 comprises a Quantum Computing Infrastructure 523, a Quantum Memory 522, and a Quantum Processor 521. The Quantum Computing Infrastructure 523 comprises physical components for housing the Quantum Processor 521 and the Quantum Memory 522. The Quantum Computing Infrastructure 523 further comprises a cryogenic refrigeration system to keep the Quantum Computing Subsystem 501 at the desired operating conditions. In general, the Quantum Processor 521 is designed to perform adiabatic quantum computation and/or quantum annealing to optimize data received from the Data Extraction Subsystem 504. The Quantum Memory 522 is comprised of a plurality of qubits used for storing data during operation of the Quantum Computing Subsystem 501. In general, qubits are any two-state quantum mechanical system. It will be understood that the Quantum Memory 522 may be comprised of any such two-state quantum mechanical system, such as the polarization of a single photon, the spin of an electron, and the like.

The Action Subsystem 502 communicates the optimized data from the Quantum Computing Subsystem 501 back to the system of the invention. It will be understood that any method of communication between the Data Extraction Subsystem 504 and the network includes, but is not limited to quantum network communication, wired communication, Radiofrequency (RF) communication, Bluetooth®, WiFi, and the like.

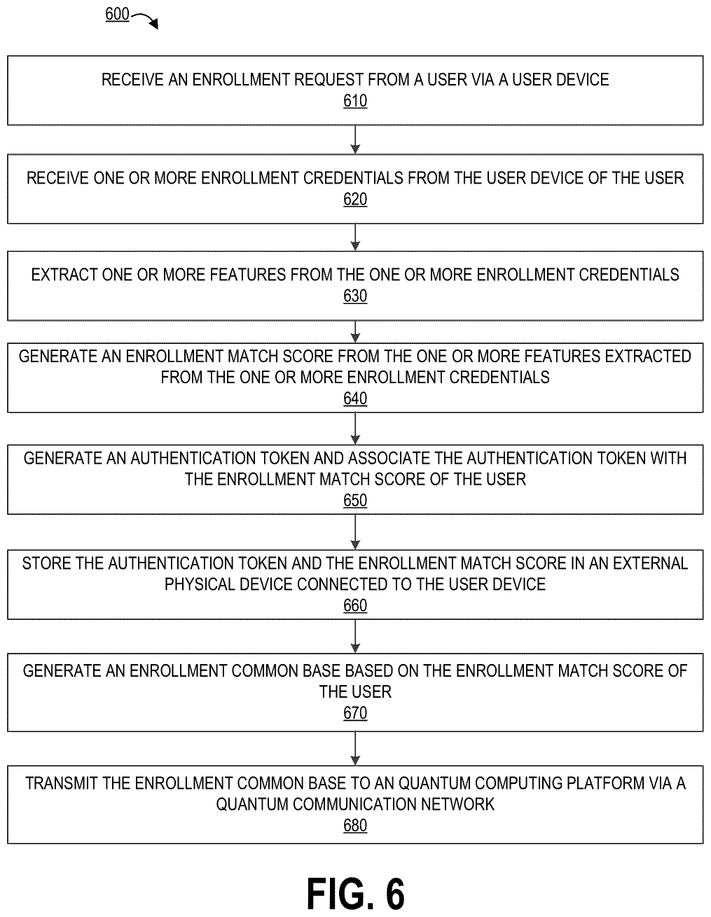

FIG. 6 provides a flowchart illustrating a process flow for enrolling one or more users for an authentication service provided by the enhanced secure authentication system 300, in accordance with an embodiment of the invention. As shown in block 610, the system receives an enrollment request from a user via a user device. The enrollment request may be received from the user device to register one or more credentials of the user. In some embodiments, the credentials may be biometric credentials (e.g., fingerprint, voice, retina scan, or the like). As shown in block 620, the system receives one or more enrollment credentials from the user device of the user.

As shown in block 630, the system extracts one or more features from the one or more enrollment credentials. The one or more features may comprise significant traits associated with the one or more enrollment credentials. For example, if the enrollment credential received from the user during the enrollment process is a finger print, then the system may identify fingerprint ridge patterns (e.g., arches, loops, whorls, or the like) and fingerprint ridge characteristics (e.g., core, ending ridge, short ridge, fork, delta, hook, eye, dot, crossover, bridge, enclosures, specialty, or the like).

As shown in block 640, the system generates an enrollment match score from the one or more features extracted from the one or more enrollment credentials. As used herein, the term “match score” may refer to a degree of match between one or more credentials. For example, the system may prompt the user to submit more than one fingerprint after initiation of the enrollment process in block 610 and may receive more than one fingerprint from the user at the enrollment phase and may calculate the match score between the fingerprints.

As shown in block 650, the system generates an authentication token and associate the authentication token with the enrollment match score of the user. The authentication token may be any unique token that is generated to link with the enrollment match score of the user. As shown in block 660, the system stores the authentication token and the enrollment match score in an external physical device connected to the user device.

As shown in block 670, the system generates an enrollment common base based on the enrollment match score of the user. In some embodiments, the generation of the enrollment common base is based on evaluated binary values of the enrollment match score generated in block 640. Common base is a type of secret key that is shared between the user device and the quantum computing platform. Generation of common base using the quantum chip located on the user device is based on transitioning qubits in superposition states using Hadamard gates. In superposition state, qubits can no longer be in the ‘0’ state or the ‘1’ state, but have a probability distribution matrix of either of ‘0’ or ‘1’ state. When a Hadamard gate operates on a specific qubit and another Hadamard gate operates on the result of this first operation, the resulting qubit will be in the same state it had originally.

As shown in block 680, the system transmits the enrollment common base to an quantum computing platform via a quantum communication network. Transmission of the enrollment common base via the quantum communication network comprising teleporting the enrollment common base completely to the quantum computing platform without storing it in the user device or the system of the present invention.

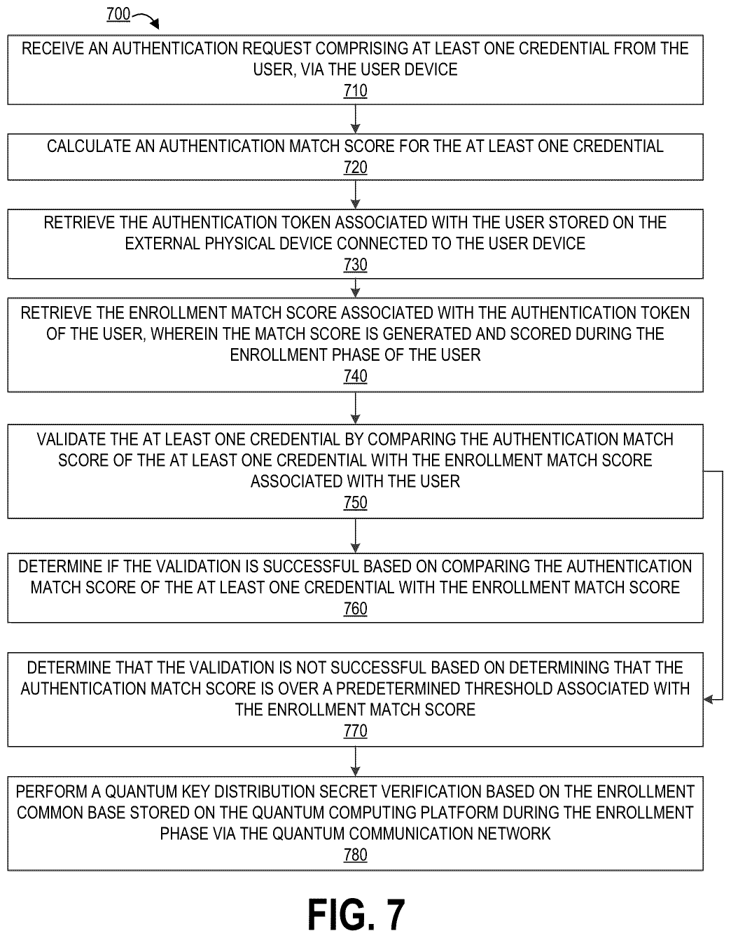

FIG. 7 provides a flowchart illustrating a process flow for processing an authentication request received from one or more users, in accordance with an embodiment of the invention. As shown in block 710, the system receives an authentication request comprising at least one credential from the user, via the user device. The at least one credential may be the same type of credential that was enrolled during the enrollment phase. For example, if the user has enrolled in the authentication service provided by the system of the present invention using a fingerprint, the authentication request submitted by the user at a later time period comprises an authentication fingerprint.

As shown in block 720, the system calculates an authentication match score for the at least one credential. The system may calculate the authentication match score based on comparing the at least one credential with one or more stored credentials associated with the user. In some embodiments, the one or more stored credentials may be stored in a data repository of the system of the present invention, the entity system 200. In some embodiments, the one or more stored credentials may be one or more enrollment credentials received from the user during the enrollment process.

As shown in block 730, the system retrieves the authentication token associated with the user stored on the external physical device connected to the user device. The system may retrieve the authentication token from the hardware security module connected to the user device. As shown in block 740, the system retrieves the enrollment match score associated with the authentication token of the user, wherein the enrollment match score is generated and scored during the enrollment phase of the user. The enrollment match score is linked with the authentication token generated during the enrollment phase of the user.

As shown in block 750, the system validates the at least one credential by comparing the authentication match score of the at least one credential with the enrollment match score associated with the user. For example, if the enrollment match score generated based on processing the enrollment fingerprints is ‘X,’ the system calculates an authentication match score as ‘Y’ for the fingerprint received during the authentication phase based on comparing the authentication fingerprint with the enrollment fingerprints. The system then validates the authentication fingerprint based on comparing the value ‘Y’ with the value ‘X.’ Due to the nature of authentication, the system may establish a predetermined threshold for establishing a margin of variation. In some embodiments, the system may determine the predetermined threshold during the enrollment phase while generating the enrollment match score. For example, the system may determine that the enrollment match score between different voice samples varies by 3% based on comparing the different samples received from the user during the enrollment phase and may set the predetermined threshold as 3%.

As shown, the process flow proceeds to block 760, where the system determines if the validation is successful based on comparing the authentication match score of the at least one credential with the enrollment match score. Continuing with the above mentioned example where the enrollment match score is calculated as ‘X’ and authentication match score is calculated as ‘Y,’ the system compares ‘X’ with ‘Y’ and determines if the difference between the values is within the predetermined threshold. If the difference is within the predetermined threshold, the system determines that the validation is successful.

As shown, the process flow proceeds to block 770, where the system determines that the validation is not successful based on determining that the authentication match score is over a predetermined threshold associated with the enrollment match score. Continuing with the above mentioned example where the enrollment match score is calculated as ‘X’ and authentication match score is calculated as ‘Y,’ the system compares ‘X’ with ‘Y’ and determines if the difference between the values is within the predetermined threshold. If the difference is beyond the predetermined threshold, the system determines that the validation is not successful.

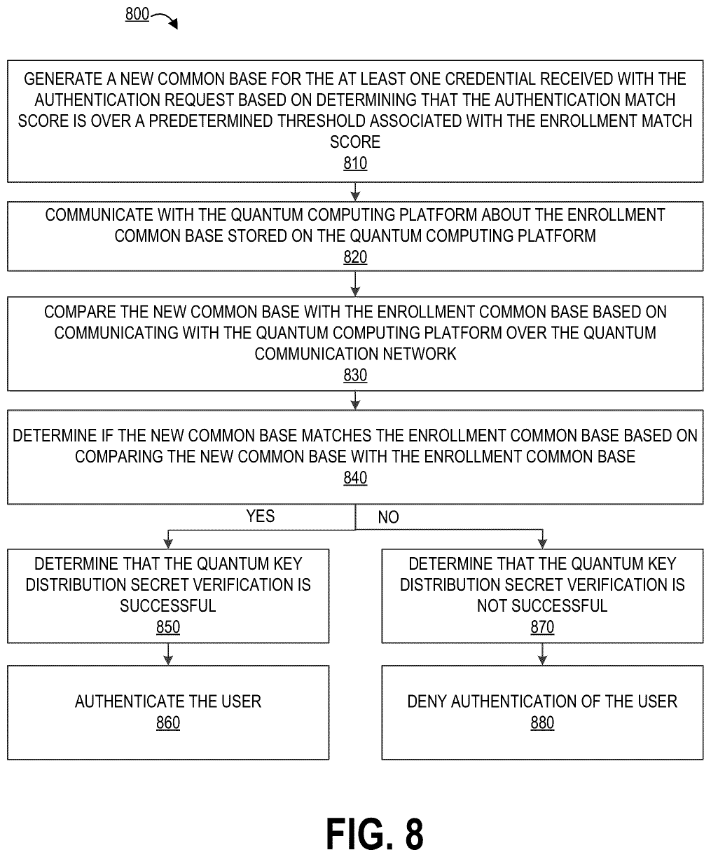

As shown in block 780, in response to determining that the validation is not successful, the system performs a quantum key distribution secret verification based on the enrollment common base stored on the quantum computing platform during the enrollment phase via the quantum communication network. The process of performing the quantum key distribution secret verification is described in FIG. 8 below.

FIG. 8 provides a flowchart illustrating a process flow for performing a quantum key distribution secret verification to authenticate users, in accordance with an embodiment of the invention. As shown in block 810, the system generates a new common base for the at least one credential received with the authentication request based on determining that the authentication match score is over a predetermined threshold associated with the enrollment match score. The generation of the new common base is based on the evaluation of binary values associated with the authentication match score determined in block 720 of FIG. 7.

As shown in block 820, the system communicates with the quantum computing platform about the enrollment common base stored on the quantum computing platform. As shown in block 830, the system compares the new common base with the enrollment common base based on communicating with the quantum computing platform over the quantum communication network.

As shown in block 840, the system determines if the new common base matches the enrollment common base based on comparing the new common base with the enrollment common base. If the system determines that the new common base matches the enrollment common base, the process flow proceeds to block 850. As shown in block 850, the system determines that the quantum key distribution secret verification is successful based on determining that the new common base matches the enrollment common base. This additional layer of validation addresses the problem of false positives and false negatives.

As shown in block 860, the system authenticates the user upon determining that the quantum key distribution secret verification is successful. In some embodiments, prior to authenticating the user, the system may perform additional authentication step, such as a One Time Password authentication, multi factor authentication, and/or the like. The system authenticates the user after a successful secondary authentication.

If the system determines that the new common base matches the enrollment common base, the process flow proceeds to block 870. As shown in block 870, the system determines that the quantum key distribution secret verification is not successful based on determining that the new common base does not match the enrollment common base.

As shown in block 880, the system denies authentication of the user upon determining that the quantum key distribution secret verification is not successful. The system may then display an error message via a user interface. The system may also transmit additional notifications via a registered communication channel to the enrolled user about the failed authentication attempt.

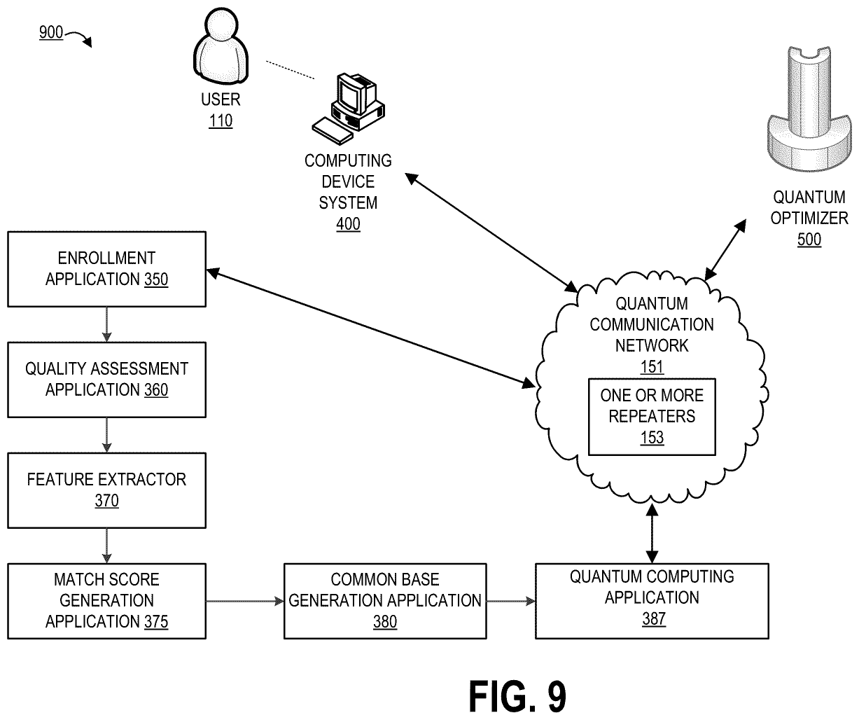

FIG. 9 provides a block diagram illustrating the process of enrolling one or more users for the authentication service provided by the enhanced secure authentication system 300, in accordance with an embodiment of the invention. In some embodiments, communication between different systems of the network may be performed through a combination of network 150 and the quantum communication network 151. In some embodiments, communication between different systems of the network may be performed only through the quantum communication network 151. As shown, the user 110 via, the computing device system 400, communicates with the enrollment application 350 of the system of the present invention, where the user 110 provides one or more enrollment credentials. In some instances, the enrollment application 350 may prompt the user on the computing device system 400 to provide more than one sample of the credential (e.g., more than one sample of retinal scan, voice, fingerprint, or the like). The enrollment application 350 passes the one or more enrollment credentials to the quality assessment application 360 which analyzes the one or more enrollment credentials. After analyzing, the one or more enrollment credentials are transmitted to the feature extractor 370 which extracts one or more features of the one or more enrollment credentials and the one or more features are used by the match score generation application 375 for generating an enrollment match score. The match score generation application 375 then generates a token generated and associates the token with the enrollment match score and is stored on the hardware security module 405 of the computing device system. The binaries of the enrollment match score are then analyzed by the common base generation application 380 to generate an enrollment common base associated with the user and the enrollment match score of the user. The enrollment common base is transmitted over the quantum communication network 151 to the quantum computing platform 500.

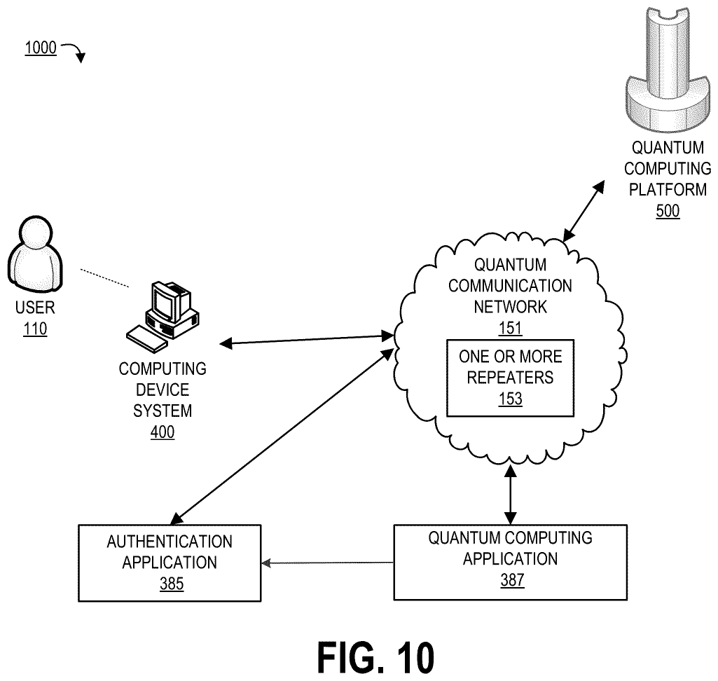

FIG. 10 provides a block diagram illustrating the process of securely authenticating users using quantum key distribution protocol, in accordance with an embodiment of the invention. As shown the user 110 initiates an authentication request comprising authentication credentials, via the computing device system 400, which is received by the authentication application 385 and is then processed. The authentication application 385 processes the authentication request by generating an authentication match score for the authentication credentials, where the authentication match score is compared with the enrollment match for validation. Upon successful validation, the user is authenticated. If the validation is unsuccessful, a new common base is generated for the authentication credential via the common base generation application 380. The authentication application 385 then validates the new common base with the enrollment common base stored on the quantum computing platform 500, via the quantum computing application 387 and the quantum communication network 151. If the validation of the new common base is successful, the user 110 is authenticated. If the validation of the new common base is not successful, authentication of the user 110 is denied.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for securely authenticating users using quantum key distribution protocol, the system comprising:
at least one network communication interface;
at least one non-transitory storage device; and
at least one processing device coupled to the at least one non-transitory storage device and the at least one network communication interface, wherein the at least one processing device is configured to:
receive an authentication request comprising at least one credential from a user, via a user device;
in response to receiving the authentication request, calculate an authentication match score for the at least one credential;
retrieve an authentication token associated with the user stored on an external physical device connected to the user device;
retrieve an enrollment match score associated with the authentication token of the user, wherein the enrollment match score is generated and scored during an enrollment phase of the user;
validate the at least one credential by comparing the authentication match score of the at least one credential with the enrollment match score associated with the user; and
determine if the validation is successful based on comparing the authentication match score of the at least one credential with the enrollment match score.

2. The system of claim 1, wherein the at least one processing device is configured to:
determine that the validation is not successful based on determining that the authentication match score is over a predetermined threshold associated with the enrollment match score; and
perform a quantum key distribution secret verification based on an enrollment common base stored on a quantum computing platform during the enrollment phase via a quantum communication network.

3. The system of claim 2, wherein the at least one processing device is configured to perform the quantum key distribution secret verification based on:
generating a new common base for the at least one credential received with the authentication request;
communicating with the quantum computing platform about the enrollment common base stored on the quantum computing platform; and
comparing the new common base with the enrollment common base based on communicating with the quantum computing platform over the quantum communication network.

4. The system of claim 3, wherein the at least one processing device is configured to:
determine that the new common base matches the enrollment common base based on comparing the new common base with the enrollment common base;
determine that the quantum key distribution secret verification is successful based on determining that the new common base matches the enrollment common base; and
authenticate the user based on determining that the quantum key distribution secret verification is successful.

5. The system of claim 3, wherein the at least one processing device is configured to:
determine that the new common base does not match the enrollment common base based on comparing the new common base with the enrollment common base;
determine that the quantum key distribution secret verification is not successful based on determining that the new common base matches the enrollment common base; and
deny authentication of the user based on determining that the quantum key distribution secret verification is successful.

6. The system of claim 2, wherein the at least one processing device is configured to:
receive an enrollment request from the user at a previous instance;
perform enrollment of the user, wherein the enrollment of the user during the enrollment phase comprises:
receiving one or more enrollment credentials from the user device of the user;
extracting one or more features from the one or more enrollment credentials;
generating the enrollment match score from the one or more features extracted from the one or more enrollment credentials;
generating the authentication token and associate the authentication token with the enrollment match score of the user;
storing the authentication token and the enrollment match score in the external physical device;
generating the enrollment common base based on the enrollment match score of the user; and
transmitting the enrollment common base to the quantum computing platform via the quantum communication network.

7. The system of claim 1, wherein the at least one credential comprises biometric credentials.

8. A computer program product for securely authenticating users using quantum key distribution protocol, the computer program product comprising a non-transitory computer-readable storage medium having computer executable instructions for causing a computer processor to perform the steps of:
receiving an authentication request comprising at least one credential from a user, via a user device;
in response to receiving the authentication request, calculating an authentication match score for the at least one credential;
retrieving an authentication token associated with the user stored on an external physical device connected to the user device;
retrieving an enrollment match score associated with the authentication token of the user, wherein the enrollment match score is generated and scored during an enrollment phase of the user;
validating the at least one credential by comparing the authentication match score of the at least one credential with the enrollment match score associated with the user; and
determining if the validation is successful based on comparing the authentication match score of the at least one credential with the enrollment match score.

9. The computer program product of claim 8, wherein the computer executable instructions cause the computer processor to perform the steps of:
determining that the validation is not successful based on determining that the authentication match score is over a predetermined threshold associated with the enrollment match score; and
performing a quantum key distribution secret verification based on an enrollment common base stored on a quantum computing platform during the enrollment phase via a quantum communication network.

10. The computer program product of claim 9, wherein the computer executable instructions cause the computer processor to perform the step of performing the quantum key distribution secret verification comprises:
generating a new common base for the at least one credential received with the authentication request;
communicating with the quantum computing platform about the enrollment common base stored on the quantum computing platform; and
comparing the new common base with the enrollment common base based on communicating with the quantum computing platform over the quantum communication network.

11. The computer program product of claim 10, wherein the computer executable instructions cause the computer processor to perform the steps of:
determining that the new common base matches the enrollment common base based on comparing the new common base with the enrollment common base;
determining that the quantum key distribution secret verification is successful based on determining that the new common base matches the enrollment common base; and
authenticating the user based on determining that the quantum key distribution secret verification is successful.

12. The computer program product of claim 10, wherein the computer executable instructions cause the computer processor to perform the steps of:
determining that the new common base does not match the enrollment common base based on comparing the new common base with the enrollment common base;
determining that the quantum key distribution secret verification is not successful based on determining that the new common base matches the enrollment common base; and
denying authentication of the user based on determining that the quantum key distribution secret verification is successful.

13. The computer program product of claim 9, wherein the computer executable instructions cause the computer processor to perform the steps of:
receiving an enrollment request from the user at a previous instance;
performing enrollment of the user, wherein the enrollment of the user during the enrollment phase comprises:
receiving one or more enrollment credentials from the user device of the user;
extracting one or more features from the one or more enrollment credentials;
generating the enrollment match score from the one or more features extracted from the one or more enrollment credentials;
generating the authentication token and associate the authentication token with the enrollment match score of the user;
storing the authentication token and the enrollment match score in the external physical device;
generating the enrollment common base based on the enrollment match score of the user; and
transmitting the enrollment common base to the quantum computing platform via the quantum communication network.

14. The computer program product of claim 8, wherein the at least one credential comprises biometric credentials.

15. A computer implemented method for securely authenticating users using quantum key distribution protocol, wherein the method comprises:
receiving an authentication request comprising at least one credential from a user, via a user device;
in response to receiving the authentication request, calculating an authentication match score for the at least one credential;
retrieving an authentication token associated with the user stored on an external physical device connected to the user device;
retrieving an enrollment match score associated with the authentication token of the user, wherein the enrollment match score is generated and scored during an enrollment phase of the user;
validating the at least one credential by comparing the authentication match score of the at least one credential with the enrollment match score associated with the user; and
determining if the validation is successful based on comparing the authentication match score of the at least one credential with the enrollment match score.

16. The computer implemented method of claim 15, wherein the method comprises:
determining that the validation is not successful based on determining that the authentication match score is over a predetermined threshold associated with the enrollment match score; and
performing a quantum key distribution secret verification based on an enrollment common base stored on a quantum computing platform during the enrollment phase via a quantum communication network.

17. The computer implemented method of claim 16, wherein performing the quantum key distribution secret verification comprises:
generating a new common base for the at least one credential received with the authentication request;
communicating with the quantum computing platform about the enrollment common base stored on the quantum computing platform; and
comparing the new common base with the enrollment common base based on communicating with the quantum computing platform over the quantum communication network.

18. The computer implemented method of claim 17, wherein the method comprises:
determining that the new common base matches the enrollment common base based on comparing the new common base with the enrollment common base;
determining that the quantum key distribution secret verification is successful based on determining that the new common base matches the enrollment common base; and
authenticating the user based on determining that the quantum key distribution secret verification is successful.

19. The computer implemented method of claim 17, wherein the method comprises:
determining that the new common base does not match the enrollment common base based on comparing the new common base with the enrollment common base;
determining that the quantum key distribution secret verification is not successful based on determining that the new common base matches the enrollment common base; and
denying authentication of the user based on determining that the quantum key distribution secret verification is successful.

20. The computer implemented method of claim 16, wherein the method further comprises:
receiving an enrollment request from the user at a previous instance;
performing enrollment of the user, wherein the enrollment of the user during the enrollment phase comprises:
receiving one or more enrollment credentials from the user device of the user;
extracting one or more features from the one or more enrollment credentials;
generating the enrollment match score from the one or more features extracted from the one or more enrollment credentials;
generating the authentication token and associate the authentication token with the enrollment match score of the user;
storing the authentication token and the enrollment match score in the external physical device;
generating the enrollment common base based on the enrollment match score of the user; and
transmitting the enrollment common base to the quantum computing platform via the quantum communication network.
